(19) United States
(12) Patent Application Publication
(10) Pub. No.: US 2016/0070546 A1
(43) Pub. Date: Mar. 10, 2016

(54) COMPUTER PROGRAMMING SYSTEM AND METHOD

(71) Applicant: Aquameta LLC, Portland, OR (US)

(72) Inventor: Eric Hanson, Portland, OR (US)

(21) Appl. No.: 14/848,317

(22) Filed: Sep. 8, 2015

Related U.S. Application Data
(60) Provisional application No. 62/046,944, filed on Sep. 6, 2014.

(51) Int. Cl. G06F 9/44

(52) U.S. Cl. CPC G06F 8/35; G06F 8/31

(57) ABSTRACT

A method of computer programming includes the steps of making a writable system catalog, and developing grammar by building an abstract grammar tree. Another method of computer programming involves use of a data model and a user interface, and includes the step of decoupling the user interface from the data model.

### CROSS-REFERENCE TO RELATED APPLICATIONS

This application claims priority to U.S. Provisional Patent Application Ser. No. 62/046,944, filed Sep. 6, 2014 and entitled “Computer Programming System and Method”, the disclosure which is incorporated herein by reference.

So I'm going to talk today about data versioning, but before I dive into that I'm going to talk about the bigger picture of why we're doing what we're doing, and to do that, I'm going to take a big step back and look at the industry. It's a grand act of hubris to try to describe the software industry. All stories are just one story, all stories are false in a sense, but we've got one and we're going to take a crack at it, so here goes.

So, once upon a time there were no end users of software. Computers had existed for decades, but they were only accessible by highly skilled technicians, who were considered the wizards of the day. It might sound a bit familiar when we fast forward to today, and our role in the industry. But they weren't accessible by end users, and even that idea that a computer could have a role in a normal person's life was a radical idea at the time.

And then of course we know the history, everybody does, these crazy people, these radical people had this idea of personal computing, that a person could use a computer in their lives. And that idea was met by great skepticism at the time. There are all these great quotes about how much ram will be enough, well there are some great quotes why people will never need to use a computer.

But history proved them right, and we fast forward to today, and what we see is that everyone uses computers. It's become an essential part of being a human today.

So that transition from the late 70s and the advent of personal computing to today, when we look at it, we see a progressing line, kind of a gradient, of things that end users can do that computer have been able to do for a long time. Iconic examples include desktop publishing, where before desktop publishing, computers had been producing documents for a long time, but they used languages like LaTeX, things that were far from accessible by end users. Not that there's anything wrong with LaTeX, but it's far from accessible.

We see this all over the place. The capacity to email, computers had been able to send messages to each other for a long time, but now on our iPhone you can hardly make a mistake, it's so easy.

So, we look at that and we've come so far, and yet there's still a divide between the producers and the consumers of software.

So, we're the intercessors to the power of computing. We play the role of gatekeepers. And considering how much computers have changed our world, that role, we all look at it but we don't about it that much. We play the role of intercessor to the power of computing, and computing is transforming our world, fundamentally changing what it means to be a human from what it meant 30 years ago. Our social interactions, our commerce structures, the whole thing. And I believe, you know, Larry Ellison says the digital revolution is over, and everybody should go into bioinformatics, and I say we're in the Model T era of the digital revolution, we've barely started.

So, this role as intercessor to the power of computing is a big, I'm not going to say it's a problem because to say it's a problem means to say that it's bad. But it's important I think to look at what might be possible if it didn't exist. We create software our users on their behalf, and that means that they are the domain experts, and for us to create software for our clients, we have to understand their world. There's this knowledge transfer that has to happen. In consumer apps, software is pretty good these days, it's pretty easy to use, but you dive into the enterprise and what you find in my experience is that everybody hates their software because it's a custom solution that 60 people use, and there isn't this profound pressure make a really nice user experience. We make something that works so we can run our company.

These users, they can imagine how they can fix their software but they can't fix it themselves. So it's a bottleneck to creativity and innovation. It's a disincentive to change. This is Darwin by the way, where, when we embrace software the way that we do, it becomes the nervous system of our organization, and it really defines what our organization does in a lot of ways. Many companies simply could not exist without their software, and it's historically unprecedented that a CEO can't just show up at a company and say “Today we're going to do it like this. We've been doing it like this forever, but today we're going to do it like this. We're just going to go try something new.” That capacity has been deeply inhibited because it's like “Today we're going to tell the programmers to do it like this, and then six weeks or six months later we're going to try it out, and if it doesn't work well, then we just spent 50,000 on trying it this new way.”

And then when an organization has to change, Darwin talks about this at the biological level. When an organism has to change, their survival, their fitness is their capacity to adapt to that change. Not their strength in the moment, but inevitably there will be a sudden change, and that capacity to adapt to that change is what determines their fitness, whether we survive or not. And the way we as a species have embraced computer technology, I believe, has disincentivized change, and that it's a massive liability for our species.

So you know it's a wonderful opportunity to make things better.

So, what would it look like if programming were easy, that's what we're going to talk about. It would be a huge opportunity, it would be an explosion of innovation, it would empower end users to collaborate in ways that they can't right now. How many times have you heard, “I've got this great idea for an app.” That somebody has, and then you know they don't have 50 grand to go and find developers to do it. Well, if that barrier ever came down, I think we would see an explosion of a certain type of applications. Because when you look at what it takes to create software today, it takes either skill or money. And not everybody has those things, and those that do, have largely driven the digital revolution. What would it look like for the disempowered to be able to make software, to be able to change the world in the way that they would like to, vs the ways that big companies would like to.

I think it would open some doors, and I think it would make the world a better place, not to quote Silicon Valley. So this is not a new goal, Hypercard, Logo, Scratch, Lego Mindstorms. You know that Python was actually intended to be an end user programming environment? [So was COBOL. So was SQL.]

SQL was too that's right. Why is that not on here? SQL is like a simple query Language, it's just like English, you just write it up!

VisiCalc, you know, I still that that spreadsheets are the coolest end user programming environment. People do amazing things with spreadsheets. My friend over at the department of health and welfare, he Oracle was coming in to put in this $900,000 system and he was like “I can do this all in spreadsheets”, and did it! And proved it, and took it to his boss and he was like “Well, that doesn't fall within our blah blah blah” and you know it wasn't a robust piece of software, but it proves, he wasn't a computer programmer, he was an untrained power user that was making software that functioned with the same function as a million dollar system.

So we're working on a system, like many before us, that empowers end users to create software. I think our approach is a little bit unique. It's free, open source, web based end user programming environment. It's not entirely open source yet, there are things that we have developed that are general purpose, and I'm going to show you one of those today, and then the rest really work with each other to create a system that's targeted at end users, and the intent is for all of it to be open source, but right now we've just taken the things that are generally useful and open sourced those.

So, what's our approach? How are we doing this and why am I talking about this to a database group? Well, we start with first principles. This is a great quote from Elon Musk,

I think it's important to reason from first principles rather than by analogy. The normal way we conduct our lives is we reason by analogy. We are doing this because it's like something else that was done, or it is like what other people are doing. Slight iterations on a theme.

“First principles” is a physics way of looking at the world. What that really means is that you boil things down to the most fundamental truths and then reason up from there.

Our first principle is Classification and Distinction, which, I'm going to talk about it in philosophically but you probably already know what it is in the real world, which is data. Classification and distinction is a way of organizing and making sense of the world that says, we put things into a category that are all the same. Like we can say “All of you are all the same because you're all people, and you're all postgres users, and on and on and on.” And then distinction is “All of you are all different. All these chairs are all different.” You know, there's no stuff in this room, usually I can point to stuff that . . . all these lights are the same but they're all different.

And that sameness and differentness is, I believe, like the fundamental way we make sense of the world. It's something that animals do. You know, when an animal is scared, a horse is scared of men with hats because they were beaten by someone with hat, it's because they learned that that category of things is a threat. So, in their schema, in their database in their head of people, they have a “has_hat” boolean, right, and they equate it with danger.

Classification and distinction is so fundamental to how we make sense of the world, I think it is how we make sense of the world, at least a big part of it.

Here's a Lego block, the lowly Lego block. Classification and distinction on this, the first layer is “what is a layer”. A Lego block is this plastic thing. Lego blocks are all the same, they're all made of plastic, they all have bumps on the top and holes in the bottom. Then, how is one Lego block different from another? These are the fields, they've got a color, a length and a width. And then you notice that we've been talking about Lego blocks this whole time but we haven't describe any particular Lego block, it's all about what it means to be a Lego block in this frame. And then, what are the properties of this particular Lego block? Now we're talking about data, data describes the world.

So, “what if I told you” right? Classification and distinction can model just about anything, so we identify it as a first principle and build up from there.

So, as a first principle, we have to come back and reassess what it means to be a programmer from this place of first principle. And, we ask the question “How do we model our tools as programmers, as data, using classification and distinction.”

So, we start with, you know, the thing about Postgres and all databases is that, that's what they do. They are mechanisms for storing classifications and distinctions. Set theory is another way to frame what they are.

But, we chose postgres, “on the back of an elephant” because it's fricking awesome. You know, I've been working intensely with postgres for the last, I mean, we used postgres in the enterprise, you know, in the back of the closet for years, but we really dove into what it can do in the last two years, and I couldn't love a piece of technology more than I love postgres. We discover new things it can do all the time.

So, this is the database. If you break it up as a pie, you can break it into three different pieces of pie: The Data Definition Language (DDL), that's schema create, create table, that stuff, and we also include in there all the other stuff that postgres does, that isn't necessarily data definition language, like, foreign tables. Who knows what a foreign data wrapper is? We include that in there too.

The Data Manipulation Layer, the DDL, that is changing of data.

DQL, the Data Query Language, is the reading and recombining.

So, the first part of this system is a writable system catalog. Ok what is that? Who knows what the system catalog is? The system catalog is the thing that makes everything in the database look like data. You can select from the tables table. And there's actually two of them, there's the Postgres one which is called pg_catalog, and then the other one is information_schema, which is an ANSI standard, which is added on after pg_catalog, it queries the pg_catalog.

But we wanted to make one that is writable, kind of normalized, if you look both of those system catalogs, they are in my opinion kind of a mess. The naming conventions, one has the baggage of postgres before it was even an SQL database. Not that it's baggage, but it is pretty internal, it's kind of an internal representation. And then the other one is an ANSI standard, which is also laid out kind of weird. I want a table called “tables” and a table called “schemas” and a table called “columns”, and all the stuff is laid out the way we talk about it and the way we think about it.

So, we made our own. What it does is it lets you look at the system. It's made out of views, and those views, underneath the hood, what they do is query the system catalog. You can do select * from tables and you get all the tables. But the cool thing about it is you can foreign key into it and you can update it. It's not exactly a foreign key, we invented a type system, this is not the point of my talk but we have to survey this to know a bit about how we did the data versioning. We invented a type system where there's things called table_id, where it can reference a table, and column_id, and that kind of thing. You can do stuff like, “insert into table (name) . . . ” and so it's a writable system catalog.

So to revisit our first principle, what that means is that we've made the database so you can manipulate it as if it was data. It means that in theory, all you would ever have to, with this writable system catalog, is insert update and delete. You can do all the stuff that postgres can do by only doing inserts updates and deletes. That's the theoretical goal. Now have we achieved that? No, not entirely, there's all kinds of postgres does that it's like, is that really that important for our needs? We're not going to do security barriers. You can't insert a security barrier. But, maybe someday we'd like to, full coverage would be great.

So, this is the stuff we have coverage of in the database. There's views and tables and schemas and roles and relations and functions, foreign keys, constraints, connections. Connections is one of my favorite. That's everybody who is connected to the database, and then you can go in and delete one of those connections, it will kick them out.

Select * from connection, right?

And you see that I'm the only person connected right now.

Ok, select * from relation. What you see here is an identifier, a schema_id, a schema_name, the name of the table, what's it's primary key, so on and so forth.

Select * from function.
\d+role

Ok, here's a role, what you see is, is it a super user, these Booleans are it's permissions, there's it's password, so I can select * from role, and there are only two roles, and these are those roles.

But now if I want to create a users, I can insert into role and it will create a user. I'm not going to type it all out right now, but it's an example, you see these view triggers that, what they do is go and create the roles.

So, that's the system catalog. Does that all make sense?

That's our architecture layer one.

We make creation of the structure consistent with the manipulation of the structure. There's a word for that, it's called homoiconicity. And, the only database that I know of that does this isn't actually a database at all, but it's RDF. There's the class of classes, and properties are in the class of properties, and it's all super meta and super weird and gets hard to work with. But, still pretty cool.

Layer two is the grammar. And what the sql layer does is it takes SQL, and we build an abstract syntax tree for SQL, as tables in a database, and that means that you can do inserts into these tables, and what they do is produce SQL statements. There's a parser in there and a toString in there to go in and out, and so you can manipulate a SQL statement using inserts and updates. And so, it's cumbersome as hell, you know, as a user you'd much prefer to type the SQL out, but that's not we were going for. We were going for, like, granular manipulation of SQL, so that you can build a user interface against it.

The really cool thing about this first principle is that when you make everything in the stack look like data, then what you're doing is creating programs and creating queries and managing the database using only inserts, updates and deletes. And what that means is that we can write applications against it so that the user interface is decoupled from the data model. So you can experiment with the user interface and try all kinds of different user interfaces and yet under the hood all they're doing is only manipulating data.

We've been building user interfaces that manipulate data, you know, forever. I mean, that's what we all do all day as web programmers anyway, if you're a web programmer, that's what you do. You make user interfaces that manipulate data. So it takes all that massive amount of expertise that we have at that pattern, and it points it at end user programming, so that we can now make user interfaces. I'm going to jump to a demo of that.

So, this is a query editor. What you see right here is this bi-directional relationship between code up here and this user interface right here. What this is is a user interface, and then you've got manipulators right here, and then results down at the bottom. But, what this does is, turn one of those on and off, and, you see what happens there? Take a look at this query when I click this. And it pops the boat.bname in there. Now lets take this limit and change it to a 2. And the results change.

So you get this bi-directional relationship between code and user interface. And what's happening under the hood here is, and this is arcane, you guys gotta check this out. sql_simple. Ok, this is the abstract syntax tree of sql. So what you have in here, you can select * from from_clause. So, what's a from clause? Well, it's a join_statement list followed by a table_expression. And we could go into this, but what this is basically is the internals of the sql grammar represented as tables in the database. And so, to build a user interface against this, oh I want to make a join, I just insert a couple fields into this thing, and then it reproduces the whole thing and you can run the toString and on and on and on.

So the big first principle here, I'm going to say it one more time because it's the most important concept I'm trying to get across here today, which is that, when you make everything data, you can make user interfaces for it, and we're really good at that. So the goal is to take the entire programming stack, make it look like data, and then kind of crowd source the creation of user interface for it, so that we can create this swirly abyss of different approaches to user interfaces, and try them, and some won't work, and some will work great for kids, and some will work great for old people and blind people and whatever, and yet underneath the hood is this really nice data model that is consistent and all the user interfaces can coexist and work against this data model.

You can turn on a distinct, and throw in an offset. Oh but the thing I didn't show you is that you can change the code too. Like when I go up and delete this, it has to redraw the whole user interface, but when it does, it redraws it right. I change this 2 to a 4, and it puts the 4 down in there.

And you can also just start typing. Select * from meta.table and, oh, there I finally did something right and it takes it and run with it. And we can do this with any language. There's a general purpose pipeline by which we put in an EBNF grammar, and what comes out the other side is a bunch of tables and a parser and a to string. So if you wanted to make a kick ass regex editor, you take the ebnf for regex, dump it into the beginning of this pipeline, what you get out the other side is an abstract syntax tree for regexes in the databases, a bunch of tables, and a toString and a parser. So to make a user interface that edits regexes is just a matter of manipulating the data structure that is the abstract syntax tree of regex. Does that all make sense? I'm jumping around a bit.

But anyway, this has been a really fun project and we've learned a lot, but we've also learned a lot about why people don't like databases. They don't teach them in school, which I think is absolutely absurd, and then programmers come out of school and don't have a real good relationship with them. And there are a few reasons for that, and this data versioning thing I want to show you is one of those reasons.

For source code, we've got data versioning, or code, file versioning and we use it all the time. But when it comes to the database, how do you do versioning in the database? And you run into this a lot, like in a CMS, where you've got some code on the filesystem, and then you've got some data in the configuration system, and you try to do devops, and roll out a new release of your code and then you've gotta grab all that data and try to pull it in here and figure out how to snapshot and pull it in, and it's kind of an unsolved problem as far as I know.

We've ran at this wall three times, and I'm going to briefly show you each. Let's start with this one.

So this guy right here, what you're looking at is a . . . you know what FUSE is? It makes things look like filesystems, but behind the scenes it's off doing whatever else it's doing. So we made one of those for postgres. And what you see here, this is, I go into db and I ls and what I see is all the different schemas in this database. Now this happens to be a big mess. But, let's go into widget, and I do ls, and what I see is, now we're looking at tables, and so what we have here is the tables in the widget schema, and what we have here is that represented as a filesystem. So I go into widget and what i see is, these are all the primary keys in the widget table, but they're directories. So I'm going to cd into 5 and do ls, and these are all the fields in a single row of a widget. So lets jump back over to [the database] and I do \d widget, you see these fields up here, you see id, name, pre_js, post_js, and over they're all files. Now I'm going to cat name. So I jump back over here [to database] and I do “update widget set name=‘newer_widget’ where id=5”. So now let's cat name again, and you see now it's called “newer_widget”, right? So it's a bi-directional relationship. It's treating the database like a filesystem.

So, why did we do that? Because we have data as files, so we can just take any version control system like git or whatever and say “git add this schema” and it'll just take the whole thing and dump it into, and you can keep it like that and go make some data changes and . . . yeah go ahead.

[But you say it's bi-directional, so what happens, can you vi or whatever the file and it'll change the database?]

Yes. Lets do that.

Now let's vi name, and change it back to new_widget, and jump back here and select name from widget where id=5, and that's what just happened yes. [so somebody actually implemented a fuse thing years ago, but it was unidirectional. You couldn't update.]

[Also it's dependent on having single column foreign keys]

Yeah totally, but it's a toy, but we're not using and, so, this is approach number one and, what we didn't like about it, that's a really big one that you have to have a primary key and it has to be a single column key, but two, it's not data. It didn't follow our first principle. How do I do a commit when, you have to drop back into git, and we want version control to be something the user can do, so we have to model version control as data, just like we did everything else.

So, how do you think we modeled version control as data? This is a test the audience. What does that mean? What postgres feature screams out use me when we want to model some weird thing off in the corner as data?

[inheritance? foreign data wrapper]

Foreign data wrapper! So what we did is we made a git foreign data wrapper. We literally have like 24 git repositories just filled with insanity and we got to do two years of pure science where we just like tried everything we could think of.

So set search_path=git. \dE to show our foreign tables. What we have here, so first lets do select * from repository. So this is the only table in the system, and when you insert into this, what you do is wake up another repository out on the filesystem someplace. So what you see then is we've got reuirejs, so I'm going to open up a new shell here, and cd into that and what you see is we've got a little repository here, and it looks like the one we saw before, but this is actual files. This is just sitting on the filesystem. And then, ok, now if I do select * from commit, what I see is all the commits. You see like author_name, author_email, raw_message, this is all the git internals, then we then mapped to, and what it's doing is at runtime, postgres is going out and look at this multicorn foreign data wrapper that uses libgit2 and then goes out and queries the repository and says ok what are all the commits, which is what “git log” does. So then we take that back and present it as data to the user. So that means you can control a git repository using direct data manipulation. And then, the other piece we did on top of this is the part that lets you do a commit that takes data and throws it into these blobs that are the internals of git. If you know how git works, it's super cool, it's a hash store, where everything has a hash and that hash is the unique identifier for the file and then if that file doesn't change in a commit, then it doesn't have to store that same file again.

And we learned so much about git internals and how it works, and we tried this out, and it's cool, and this is open source, you can get the git_fdw on bitbucket, but we learned so much about how git worked internally that we decided to start over and reimplement git in the database, which turned out to be much cleaner and much simpler and didn't have this kooky dependency called git that, i mean, it's a great system, git is fine, but we're trying to keep everything inside the database, and because they are tied to the filesystem, they were forced to make some decisions that we didn't have to make.

So, the third version of this is called ver, and it's actually on my local desktop here. And this is us implementing version control on our own, where everything that you have in there is, I found out that there are only three operations. There's really only three things that ever happen, you create a row, one, you modify a field, two, or you delete a row, which is why we didn't need a lot of what git was doing there, and treating it like a filesystem, there were a lot of things you could do that didn't make sense. Like you could make a row that was incomplete, and stuff like that, and I'm not going to take a ton of time to demo it, because I want to open it up for questions, but what it does is snapshots data and it lets you restore it.

What is claimed:

1. A method of computer programming, comprising:
making a writable system catalog; and
developing grammar by building an abstract grammar tree.

2. A method of computer programming that involves use of a data model and a user interface, comprising:
decoupling the user interface from the data model.
